(19) United States
(12) Patent Application Publication
(10) Pub. No.: US 2012/0056987 A1
(43) Pub. Date: Mar. 8, 2012

(54) 3D CAMERA SYSTEM AND METHOD

(76) Inventor: Luke Fedoroff, Los Angeles, CA (US)

(21) Appl. No.: 12/876,009

(22) Filed: Sep. 3, 2010

(51) Int. Cl. H04N 13/02; G03B 35/00

(52) U.S. Cl. 348/46; 396/326; 396/327; 348/E13.074

(57) ABSTRACT

A system and method for generating 3D images comprising a plurality of fully-adjustable optical elements arranged in pyramidical configurations on parallel planes such that the cameras have different convergent points and focal points.

### BACKGROUND OF THE INVENTION

1. Field of the Invention

The present invention relates to a camera system and method for generating 3D images.

2. Related Art

People perceive depth by associating spatial relationships between various objects based on certain cues such as: detail, occlusion, perspective, and size. Detail means that closer objects appear in more detail while distant objects appear in less detail. Occlusion means that an object that blocks another is assumed to be in the foreground. Perspective means that objects have different sizes in relation to one another. And size means that objects appear smaller the farther they are.

In a 2D image, a subject will appear flat because only its height and width are registered; a 3D image adds a dimension of depth. Because human vision is binocular, one way to perceive depth is to neurologically combine the separate images registered by the left and right eyes. To mimic this stereoscopic effect, the prior art creates 3D images by combining separate images from different viewpoints to create an illusion of depth. For example, U.S. Pat. No. 3,518,929 to Glenn discloses a 3D camera system comprising a plurality of camera units arranged to take an array of images.

Because the subject is photographed from different perspectives, the images taken at different perspectives will appear slightly different. The apparent shift in position of objects due to the images being taken from different perspectives is called parallax. The parallax effect is generally proportional to the interocular distance. The interocular distance is the distance between the two cameras taking images from two different perspectives. If the interocular distance is too large, the magnitude of the parallax will be too great such that the perspectives cannot be properly fused together, resulting in a poor quality 3D image. If the interocular distance is too little, the magnitude of the parallax will be too small such that there is less depth perception, resulting in a poor quality 3D image also. Thus, it is generally desirable to select an optimal interocular distance that is neither too great nor too small, so that there is enough parallax to create a 3D effect, but not so much that the perspectives cannot be properly fused together.

Typically, this is done by employing a camera system having multiple optical elements so that many views from an array of different perspectives can be simultaneously captured. As noted, U.S. Pat. No. 3,518,929 to Glenn discloses a system of seven cameras arranged in a straight linear array. Similarly, U.S. Pat. No. 4,475,798 to Smith et al. discloses a single camera having seven lenses arranged in a curved linear array. In such camera systems, the optical elements are invariably arranged in a linear or curved array. However, these traditional arrangements are not optimal for maximizing the number of optical elements, nor are these traditional arrangements conducive to optimizing the magnitude of the parallax. Additionally, in these traditional arrangements the cameras are only oriented to converge on one point, and the cameras also only rotate around one or two of their three independent axes of control.

### SUMMARY OF THE INVENTION

One objective of the present invention to create a multi-camera system that can optimize parallax and enhance resolution, thereby creating a higher quality 3D effect.

A second objective of the invention is to create a multi-camera system that maximizes the number of optical elements without increasing the interocular distance.

A third objective of the invention is to create a multi-camera system that permits multiple convergence points, thereby allowing deep focus. Deep focus is a cinematic term meaning that both the foreground and the background are simultaneously in focus in the same shot.

A 3D camera system and method according to the objectives of this invention is comprised of a plurality of optical elements configured in parallel planes. It should be understood that optical elements refer to either discrete camera units in a system of interconnected cameras or, alternatively, the lenses of a single camera.

In accordance with the objects of this invention, it is desirable to configure the cameras as close together as possible in order to optimize parallax and enhance resolution. Thus, the cameras are configured in a pyramidical arrangement on parallel planes. A pyramidical arrangement means that one or more cameras is placed at the apex of a pyramid, and further levels of cameras are arranged in parallel planes, or substantially parallel planes, such as to form a geometric pyramid or a geometric figure that is substantially like a pyramid. And by arranging the cameras on parallel planes, the cameras can be more compactly grouped together than if they were arranged in a linear array. The arrangement is based on the geometric principle of pyramidical stacking. Because the cameras can be optimally stacked in a pyramidical configuration, a greater number of cameras can be grouped together without unnecessarily increasing the interocular distance. In this way, more images can be taken from more cameras in a way that optimizes parallax and enhances resolution, thereby increasing the quality of the 3D image.

Additionally, the arrangement of cameras in a pyramidical configuration enhances 3D perception by mimicking the anatomy of the human eye. The human eye is curved, like a bowl, to perceive depth. By arranging the cameras in a pyramidical configuration as in the present invention, the combination of cameras act as one large 3D eye.

Further, the cameras are connected to an assembly that enables each camera to be fully adjustable. Each camera can move: 1) left to right (latitude), 2) forwards and backwards (longitude), and 3) up and down (elevation). Additionally, each camera can rotate about each of its three independent axes of control. Each camera can rotate about its vertical axis, called yaw. Each camera can rotate about its horizontal latitudinal axis, called pitch. Each camera can rotate about its horizontal longitudinal axis, called roll. Most traditional 3D camera systems only allow for independent adjustment of latitude and yaw. In the present invention, each camera allows for independent adjustment of longitude, latitude, elevation, pitch, roll, and yaw.

Because the cameras are stacked on parallel planes and are fully adjustable, the cameras are capable of being oriented such that their optical axes converging at zero points or converge on more than one points. In conventional camera systems having linearly arrayed cameras, the cameras converge on one point. In the present invention, the cameras can be oriented such that the system as a whole has zero convergence points or multiple convergence points. Because the cameras can simultaneously converge on different points, deep focus can be achieved because both the foreground and the background can be in focus simultaneously.

The apparatuses and methods of creating 2D images is well known by those of ordinary skill in the art, as is the knowledge of combining such images using software to create a 3D image.

### BRIEF DESCRIPTION OF THE DRAWINGS

FIGS. 1A & 1B are schematics of an embodiment of the present invention showing a configuration of cameras arranged in a 1-6-12 hexagonal pyramid on three parallel planes.

FIGS. 2A & 2B are schematics of an embodiment of the present invention showing the cameras oriented with zero convergence.

FIG. 3 is a schematic of an embodiment of the present invention showing the cameras oriented with two convergence.

FIGS. 4A & 4B are schematics of an embodiment of the present invention showing a configuration of cameras arranged in a 1-6-12-18-24 hexagonal pyramid on five parallel planes.

FIGS. 5A & 5B are schematics of an embodiment of the present invention showing a configuration of cameras arranged in a 1-8-16 square pyramid on three parallel planes.

FIGS. 6A & 6B are schematics of an embodiment of the present invention showing a configuration of cameras arranged in a 1-8-16-24-32 square pyramid on five parallel planes.

### DETAILED DESCRIPTION OF THE INVENTION

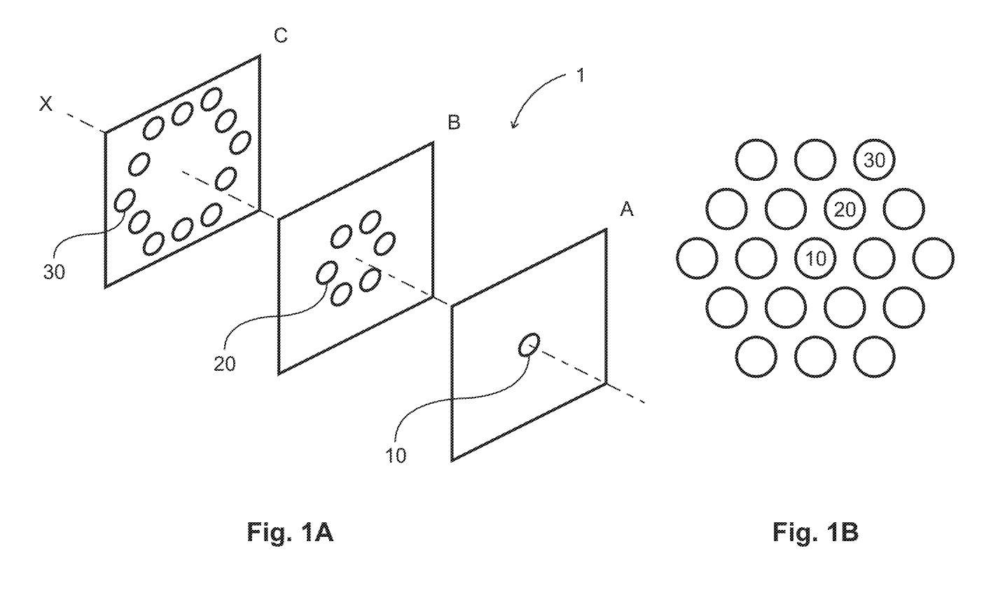

In an embodiment of the invention as shown schematically in FIG. 1A, a 3D camera system 1 for recording images of a subject is comprised of nineteen cameras arranged in three parallel planes: A, B, and C. One primary camera 10 is located on a first plane A at the apex. Six secondary cameras 20 are located on a second plane B that is parallel to the first plane A. The second plane B is located in front of the first plane A in relation to the subject X, such that the second plane B is closer to the subject X than the first plane A. Twelve tertiary cameras 30 are located on a third plane C that is parallel to the second plane B. The third plane C is located in front of the second plane B in relation to the subject X, such that the third plane C is closer to the subject X than the second plane B. As shown schematically in FIG. 1B, the nineteen cameras are stacked in a hexagonal pyramid configuration.

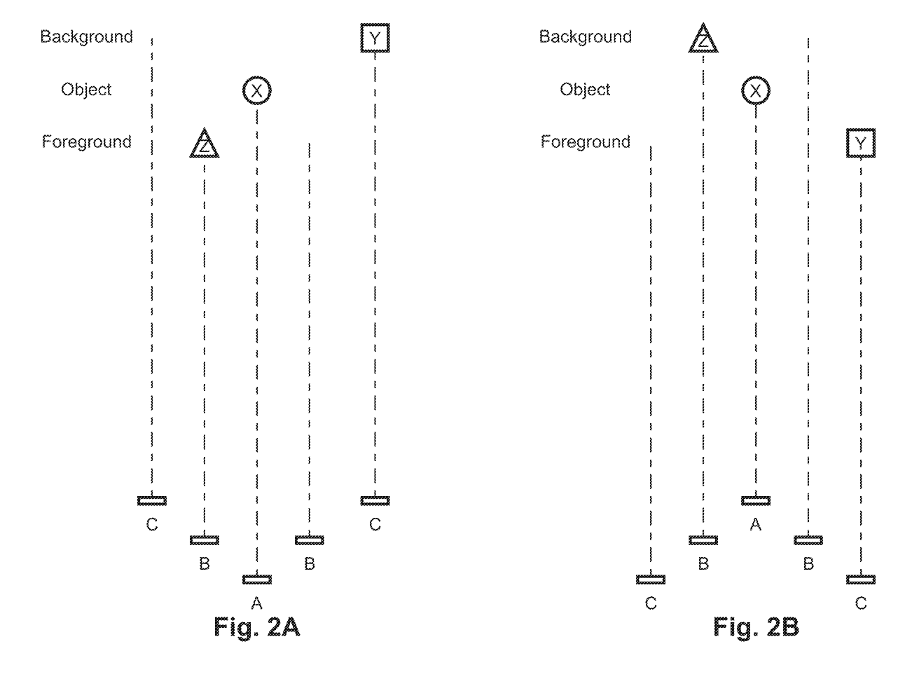

Referring to FIGS. 2A & 2B, the cameras can be oriented such that their optical axes converge at zero points. In conventional camera systems having linearly arrayed cameras, the cameras converge on one point. As shown in FIGS. 2A & 2B, in an embodiment of the invention the apex camera in the A-plane is directed at subject X, with the cameras in the B-plane and C-plane oriented exactly parallel to the apex camera such that the system as a whole has zero convergence points. Because the cameras in the 3D camera system according to the present invention can simultaneously converge on different points, deep focus can be achieved because both the foreground and the background can be in focus simultaneously.

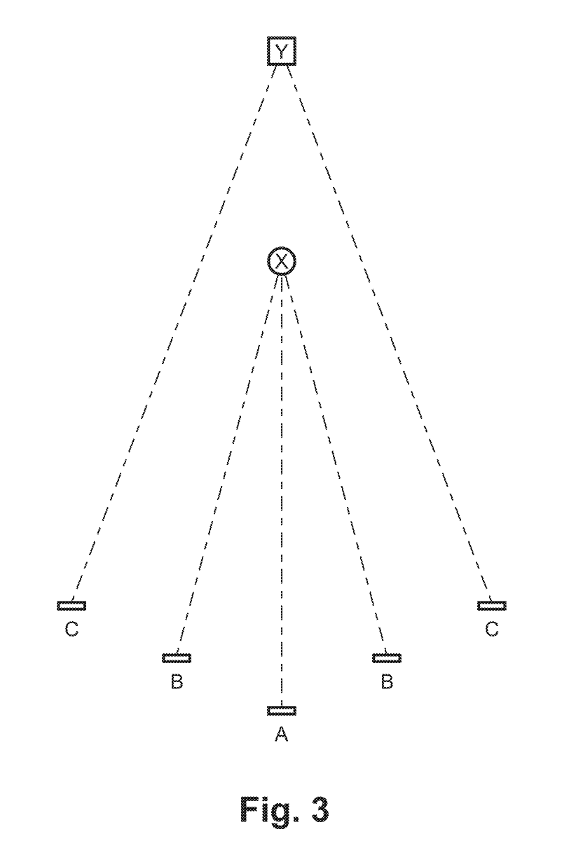

Alternatively, the cameras can be oriented such that their optical axes converge at more than one point. As shown in FIG. 3, some cameras can converge on object X, while some cameras can converge on object Y. In recording a baseball game, for example, some cameras can converge on the pitcher, and some cameras can converge on the catcher. Such a method improves 3D quality by putting both the pitcher and the catcher are in sharp focus. This is achieved by allowing for multiple convergence points, something not possible with traditional methods.

Relatedly, in addition to having different convergent points, the cameras can also have different focal points. Referring again to FIGS. 2A &2B, for example, the apex camera in plane A can be focused on the subject at point X. The cameras in plane B can be focused on a second point Z in either the foreground or background that is different from point X. Similarly, the cameras in plane C can be focused on a third point Y in either the foreground or background that is different from points X and Z. Each focal point is thus of a different focal depth from one another.

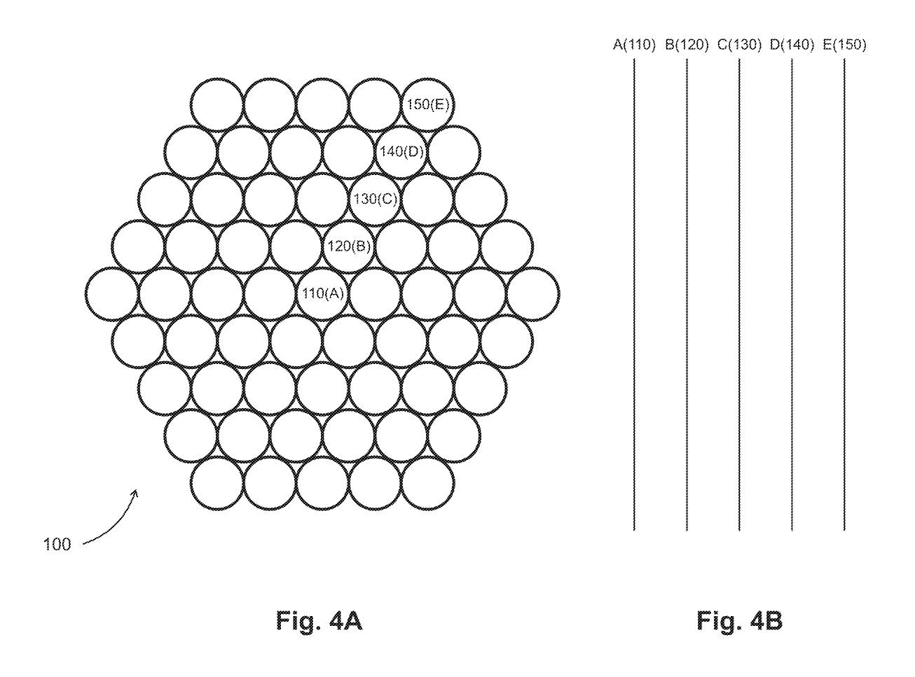

In a second embodiment 100 of the invention as illustrated by the schematics in FIGS. 4A & 4B, sixty-one cameras are stacked on five parallel planes A, B, C, D, and E in a hexagonal pyramid configuration. More particularly, a primary camera 110 is located at the center of a first plane A. Six secondary cameras 120 are symmetrically arranged in a hexagonal pattern on a second plane B. Twelve tertiary cameras 130 are symmetrically arranged in a hexagonal pattern on a third plane C. Eighteen quaternary cameras 140 are symmetrically arranged in a hexagonal pattern on a fourth plane D. And twenty-four quinary cameras 150 are symmetrically arranged in a hexagonal pattern on a fifth plane E. The order of the parallel planes A, B, C, D and E can be reversed.

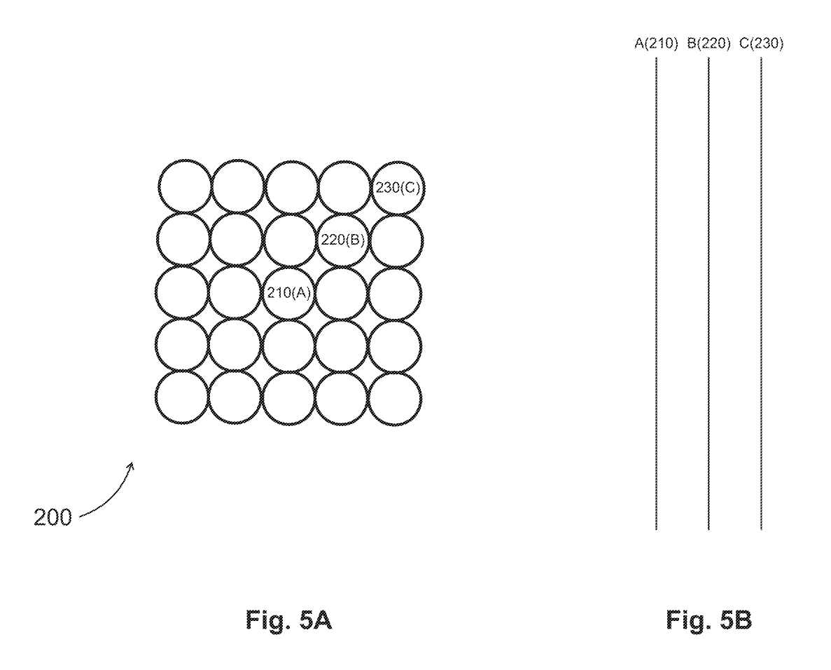

In a third embodiment 200 of the invention as illustrated by the schematics in FIGS. 5A & 5B, twenty-five cameras are stacked on three parallel planes A, B, and C in a square pyramid configuration. More particularly, a primary camera 210 is located at the center of a first plane A. Eight secondary cameras 220 are symmetrically arranged in a square pattern on a second plane B. Sixteen tertiary lenses 230 are symmetrically arranged in a square pattern on a third plane C. The order of the parallel planes A, B, and C can be reversed.

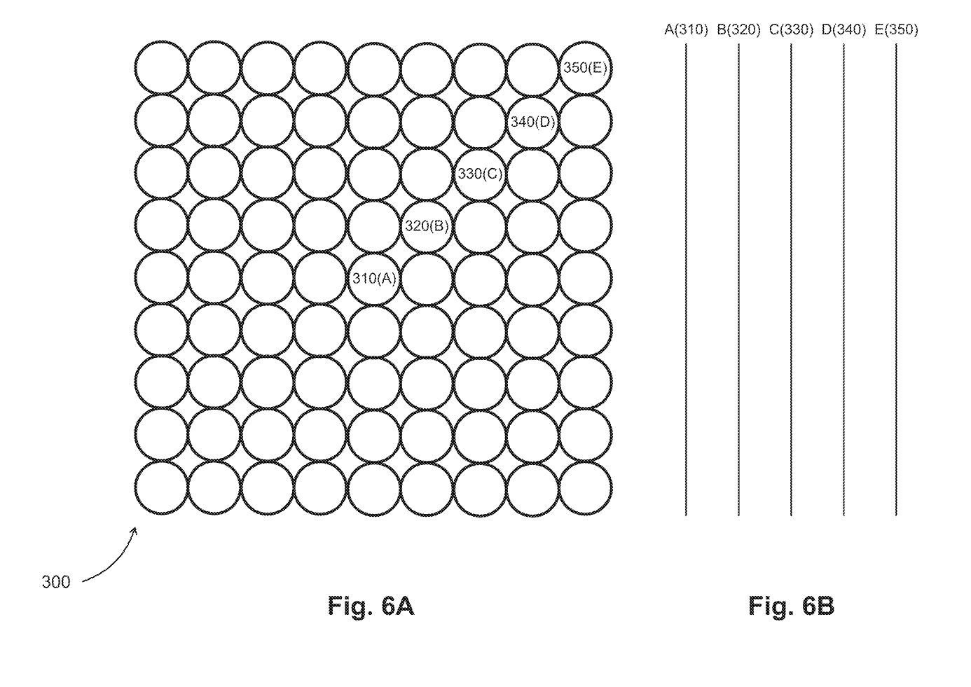

In a fourth embodiment 200 of the invention as illustrated by the schematics in FIGS. 6A & 6B, eighty-one cameras are stacked on five parallel planes A, B, C, D, and E in a square pyramid configuration. More particularly, a primary camera 310 is located at the center of a first plane A. Eight secondary cameras 320 are symmetrically arranged in a square pattern on a second plane B. Sixteen tertiary cameras 330 are symmetrically arranged in a square pattern on a third plane C. Twenty-four quaternary cameras 340 are symmetrically arranged in a square pattern on a fourth plane D. Thirty-two quinary cameras 350 are symmetrically arranged in a square pattern on a fifth plane E. The order of the parallel planes A, B, C, D and E can be reversed.

While the 3-D camera systems as described in the embodiments above comprise a plurality of cameras stacked on three or five parallel planes, one of ordinary skill in the art would appreciate that the cameras can be arranged in any number of parallel planes. Likewise, while the cameras of these embodiments are stacked in a pyramidal configuration, one of ordinary skill in the art would appreciate that the cameras could also be arranged in a conical configuration or other similar configurations.

In the 3D camera system of this invention, the cameras are freely movable in all three coordinates of space. They can be adjusted for longitude, latitude, and elevation, as well as pitch, roll and yaw. An individual camera in any particular plane can be adjusted, for example, by independently moving it up, down, or sideways. The cameras of any particular plane can also be collectively moved in unison such that the interocular distance between the lenses in the respective planes can be adjusted. Moreover, the cameras can also be moved collectively as a unit. In this way, the cameras can be translated and oriented as necessary to capture many different points of focus.

While the invention is described in connection with its preferred embodiments, it will be understood that it is not intended to limit the invention to those embodiments. On the contrary, it is intended to cover all alternatives, modifications, and equivalents as may be included within the spirit and scope of the invention as defined by the appended claims.

I claim:

1. An apparatus for generating 3D images of an object comprising a plurality of optical elements arranged with their optical faces on parallel planes.

2. The apparatus according to claim 1 further comprising:
at least one primary optical element on a first plane, said primary optical element being focused on a first point in relation to said object, said primary optical element capable of capturing a first image;
at least one secondary optical element on a second plane that is parallel to said first plane, said secondary optical element being focused on a second point that is different from said first point, said secondary optical element capable of capturing a second image;
at least one tertiary optical element on a third plane that is parallel to said second plane, said tertiary optical element being focused on a third point that is different from said first point and said second point, said tertiary optical element capable of taking a third image;
wherein said first, second, and third images are combined to form a 3D image.

3. The apparatus according to claim 2 further comprising:
one primary optical element on said first plane;
six secondary optical elements on said second plane; and
twelve tertiary optical elements on said third plane;
wherein same optical elements are arranged in a pyramidical configuration.

4. The apparatus according to claim 2 wherein said second plane is located behind said first plane in relation to said object, and said third plane is located behind said second plane in relation to said object.

5. The apparatus according to claim 2 wherein said second plane is located in front of said first plane in relation to said object, and said third plane is located in front of said second plane in relation to said object.

6. The apparatus according to claim 2 wherein each said optical element is independently movable in three directions of space.

7. The apparatus according to claim 2 wherein each said optical element is capable of rotating about its optical axis.

8. The apparatus according to claim 2 wherein each said optical element is capable of pitching about a horizontal axis that is perpendicular to its optical axis.

9. The apparatus according to claim 2 wherein each said optical element is capable of yawing about a vertical axis that is perpendicular to its optical axis.

10. An apparatus for generating 3D images of an object comprising:
a primary optical element located on a first plane, said primary optical element being focused on a first point in relation to said object, said primary optical element capable of capturing at least one first image;
at least two secondary optical elements symmetrically arranged on a second plane that is parallel to said first plane, said secondary optical elements being focused on a second point that is different from said first point, said secondary optical elements capable of capturing at least one second image simultaneously with said first image;
at least three tertiary optical elements symmetrically arranged on a third plane that is parallel to said second plane, said tertiary optical elements being focused on a third point that is different from said second point, said tertiary optical elements capable of capturing at least one third image simultaneously with said first image;
wherein said optical elements are stacked in a pyramidical configuration.

11. The apparatus according to claim 10 wherein six optical elements are arranged on said second plane in a hexagonal configuration.

12. The apparatus according to claim 10 wherein twelve optical elements are arranged on said third plane in a hexagonal configuration.

13. The apparatus according to claim 10 further comprising:
eighteen optical elements symmetrically arranged on a fourth plane in a hexagonal configuration, said fourth plane being parallel to said third plane, and said optical elements being focused on a fourth point that is different from said first point, and said optical elements capable of capturing at least one fourth image simultaneously with said first image.

14. The apparatus according to claim 13 further comprising:
twenty-four optical elements symmetrically arranged on a fifth plane in a hexagonal configuration, said fifth plane being parallel to said fourth plane, and said optical elements being focused on a fifth point that is different from said first point, said optical elements capable of capturing at least one fifth image simultaneously with said first image.

15. The apparatus according to claim 10 wherein eight optical elements are arranged on said second plane in a square configuration.

16. The apparatus according to claim 10 wherein sixteen optical elements are arranged on said third plane in a square configuration.

17. The apparatus according to claim 10 further comprising:
twenty-four optical elements symmetrically arranged on a fourth plane in a square configuration, said fourth plane being parallel to said third plane, and said optical elements being focused on a fourth point that is different from said first point, and said optical elements capable of capturing at least one fourth image simultaneously with said first image.

18. The apparatus according to claim 10 further comprising:
thirty-two optical elements symmetrically arranged on a fifth plane in a square configuration, said fifth plane being parallel to said fourth plane, and said optical elements being focused on a fifth point that is different from said first point, said optical elements capable of capturing at least one fifth image simultaneously with said first image.

19. A method for producing 3D images of an object comprising the steps of:
taking a first image using a primary optical element located on a first plane, said primary optical element being focused on a first point in relation to said object;
taking a second image using secondary optical element located on a second plane that is parallel to said first plane, said secondary optical element being focused on a second point that is of a different focal depth from said first point;
taking a third image using at least one tertiary optical element located on a third plane that is parallel to said second plane, said tertiary optical element being focused on a third point that is of a different focal depth from said first point and said second point;
capturing said images taken by each of said optical elements on a digital medium;
combining said captured images from each of said optical elements into a stereoscopic picture.

20. The method for producing 3D images of an object according to claim 19 wherein said images are taken substantially simultaneously.
